(19) United States
(12) Patent Application Publication
(10) Pub. No.: US 2026/0340534 A1
(43) Pub. Date: Oct. 29, 2026

(54) DISPATCH FREEZE FOR REAL-WORLD SCHEDULES

(71) Applicant: nMetric, LLC, Jackson, WY (US)

(72) Inventors: Christine Koski, Jackson, WY (US); Stephen Cook, Albuquerque, NM (US)

(21) Appl. No.: 19/190,605

(22) Filed: Apr. 26, 2025

(51) Int. Cl. G06Q 10/0631

(52) U.S. Cl. CPC G06Q 10/063116

(57) ABSTRACT

A system for applying a dispatch freeze for real-world schedules to account for anticipated available resources for tasks within a genome, and also to account for sudden changes in availability of those resources. A computing device generates a dispatch area that covers tasks within a genome. While those tasks are in the dispatch area, no changes can be made to the tasks or the associated resources. The system can then apply the freezes across schedules to maintain integrity and consistency across processes and resources.

### FIELD OF THE INVENTION

The field of the invention is computer-based scheduling systems.

### BACKGROUND

The background description includes information that may be useful in understanding the present invention. It is not an admission that any of the information provided herein is prior art or relevant to the presently claimed invention, or that any publication specifically or implicitly referenced is prior art.

Ordered task preparation is a common manufacturing requirement. Sometimes, there is a need to freeze an order of jobs or tasks within a job to prepare or stage resources for the job. When interruptions occur, they create large inefficiencies in the job as a whole and this can permeate to other jobs within an organization. Additional difficulties can arise if tasks are not completed on time and when a dispatch period crosses large variations in resource availability (for example, over weekends or holidays).

Thus, there is still a need for scheduling computer systems that can “freeze” an order or arrangement of jobs or tasks in order to allow for the preparation/staging and/or allotment of resources for the tasks and across the jobs.

### SUMMARY OF THE INVENTION

The inventive subject matter provides apparatus, systems and methods in which a scheduling computing device applies a dispatch freeze for real-world schedules in a genetic algorithm. The computing device analyzes a plurality of requirements for a job process, based on availability factors for a plurality of tasks associated with the job. The computing device defines, via the genetic algorithm, a sliding window that defines the dispatch area.

The computing device then inserts at least one task into the dispatch area based on the availability factors for the at least one task. The computing device then adjusts the sliding window based on additional available tasks for the dispatch area, based on the genetic algorithm determination of availability according to the availability factors and then blocks off a time and at least one resource for each of the plurality of tasks within the dispatch area.

In embodiments of the inventive subject matter, the genetic algorithm is prevented from removing tasks from the dispatch area.

In embodiments of the inventive subject matter, the computing device adjusts the sliding window based on a time availability. In some embodiments, the time availability can be a weekend unavailability or a holiday unavailability.

In embodiments of the inventive subject matter, the adjustments to the sliding window can be a contraction of the sliding window (making the sliding window cover a smaller amount of time) or an expansion of the sliding window (making the sliding window cover a larger amount of time).

In embodiments of the inventive subject matter, the computing device is programmed to store the tasks within the dispatch area for a schedule process to take place in the future.

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWING

FIGS. 1A and 1B illustrate an example of the assembly of a genome, according to embodiments of the inventive subject matter.

FIG. 2 is a flowchart of the execution of the processes, according to embodiments of the inventive subject matter.

FIG. 3A shows an illustrative example of a generated dispatch area that is applied to the genome of FIG. 1B.

FIG. 3B illustrates a modification of the dispatch area to enlarge it, according to embodiments of the inventive subject matter.

FIG. 3C illustrates the dispatch area of FIG. 3B as it moves along the genome, according to embodiments of the inventive subject matter.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms, is deemed to represent one or more computing devices having at least one processor (e.g., ASIC, FPGA, DSP, x86, ARM, ColdFire, GPU, multi-core processors, etc.) programmed to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

A computer-based scheduling system can account for one or more types of scheduling problems that can be based on factors such as the type of organization, the type of jobs and/or tasks involved, available times, etc. Some examples of the types of scheduling problems these systems are expected to handle include:

Open shop scheduling. In open shop scheduling, each job has a task on each available machine, without any types of ordering constraints. Thus, the tasks can be performed in any order. Typically, there's no parallel work on a job.

Flow shop scheduling: In flow shop scheduling, each job has a task on each machine. Unlike open shop scheduling, the order of the tasks matters in flow shop scheduling.

Permutation flow shop: Permutation flow ship is similar to flow shop scheduling, but the machine must perform the jobs (and the tasks therein) in the same order.

Job shop (“JSP”) scheduling, also known as Job-Shop Scheduling Problem (“JSSP”): the goal for JSP is to minimize “makespan”. This means that the goal for JSP is to compress the schedule as much as possible.

Flexible job shop (“FJSP”) scheduling: This is similar to the job shop scheduling, but the resources are interchangeable.

Truthful job scheduling: The resources available can perform any task in the job, but they take different time. For example, the resources can include personnel that have different skill levels at performing the task.

One challenge that computer-implemented scheduling systems face is that schedule generation for many jobs having many tasks is an “NP-hard” problem. For example, an open shop scheduling problem with “n” jobs and “m” resources has (n!)^{m} possible combinations. For 10 jobs with 10 resources, that means 3.95*10⁶⁵ possible schedules.

While scheduling types with more restrictions have a lower potential amount of schedules, the combinations are still staggering and simply too many for a computer system to brute force a “best” schedule.

Current systems use simple heuristic deterministic scheduling algorithms:

R (Random)—Pick any Job in Queue with equal probability. This rule is often used as benchmark for other rules

FCFS (First Come First Serve)—Jobs are processed in the order in which they arrived at the work center (also called earliest release date)

SPT (Shortest Processing Time)—This rule tends to reduce both work-in-process inventory, the average job completion (flow) time, and average job lateness. SPT can also be used to break ties.

EDD (Earliest Due Date)—Choose Job that has earliest due date

CR (Critical Ratio)=Processing Time/Time until due (Due Date—Current Time). Take the highest value.

LWR (Least Work Remaining)—This rule is an extension of SPT variant that considers the number of successive operations

ST (Slack Time)=Time until job is due−(Sum of processing time remaining). Take the job with the smallest amount of slack time.

ST/O (Slack Time per Remaining Operation)=slack time divided by number of operations remaining. Take the job with the smallest amount of slack time per remaining Operation.

Existing systems have also employed more “complex” scheduling heuristics, such as Johnson's Algorithm (that uses Bellman-Ford), Kusiak's Algorithm, Palmer's Algorithm, Gupta's Algorithm, Shifting Bottleneck Algorithm, Campbell-Dudek-Smith (“CDS”) Algorithm, and/or Nawas-Enscore-Ham (“NEH”) Algorithm.

However, for the most part these all simply employ variations and/or combinations of the simple heuristics. While these approaches may get acceptable results in a human-scale amount of time, none are guaranteed to find optimal solutions.

Existing scheduling systems employ fitness functions that use common variables such as processing time, release date, due date, weight, lateness, makespan, and release date. Common fitness functions will then return “raw” fitness scores that can be combined with user-supplied specific factors to weight the fitness scores. For example, an output of the fitness function can be a measure of robustness, which reflects the sensitivity of the schedule to problems/interruptions in a flow. Typically, to improve robustness, a system can add idle times, schedule less flexible jobs first, and forward-schedule as many tasks as possible. In another example, the output of the fitness function can be a measure of tightness, which minimizes the absolute size of the lateness.

As discussed herein, a job is made up of tasks. Tasks are discrete functions or processes that are the subparts of a job. The tasks of a job are often sequential such that one or more tasks may need to be completed for a subsequent one or more tasks of a job to start.

A task requires one or more resources to complete. A resource can be anything that a task may need to be completed. Examples of resources can include equipment, personnel, locations, etc.

A genome as discussed herein can be considered to be a list of tasks. In the examples discussed herein, a genome can include all of the tasks from all of the jobs associated with an organization or a process within an organization.

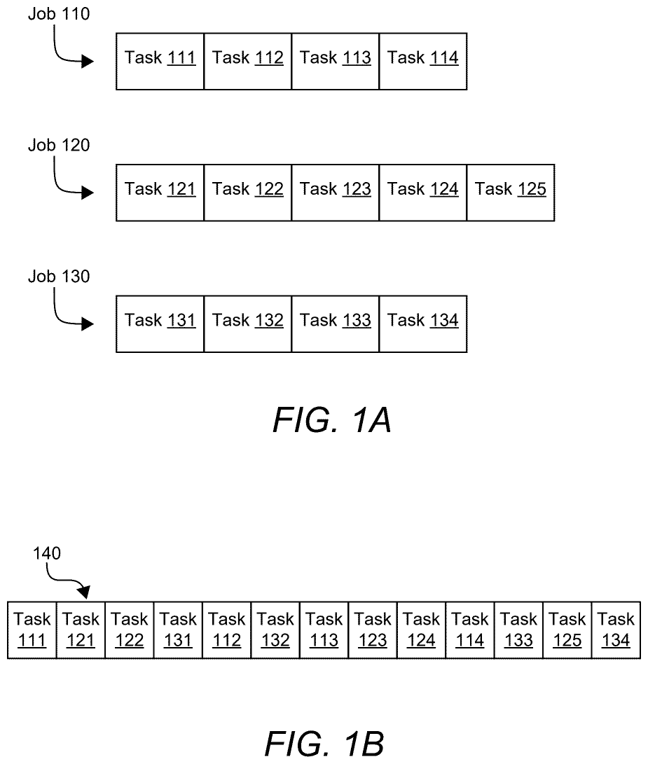

An example of the assembly of a genome is seen in FIGS. 1A and 1B.

FIG. 1A illustrates a plurality of jobs 110, 120, 130 with their respective tasks organized sequentially according to the job. Thus, job 110 will have task 1 (block 111), task 2 (block 112), task 3 (block 113) and task 4 (block 114) that need to be performed for the job 110 to be completed. Likewise, job 120 has tasks 1-5 (blocks 121-125, respectively) and job 130 has tasks 1-4 (blocks 131-134, respectively).

To create a genome, a computing device gets all of the tasks associated with all of the jobs and mixes them up to create a list from all of these tasks. FIG. 1B shows an example of a genome 140 created from all of the tasks of jobs 110, 120 and 130. Generally speaking the tasks can be mixed up in almost any order, though the assembly of a genome can be subject to rules. For example, one rule of a genome is that the tasks must be for any job along the length of the genome. This means that while the tasks of a genome are not required to be consecutive or next to one another, a task for a job cannot precede an earlier task from the same job. Thus, in this example, task 3 (block 113) of job 110 cannot be before task 2 (block 112) of the same job 110 within an assembled genome.

The jobs 110, 120, 130 and their respective tasks are relatively small in number for the purposes of illustration. It is contemplated that, in preferred embodiments, the system will handle over 10 jobs with over 10 tasks each. In still other preferred embodiments, the system will be tasked to handle over 100 jobs with many tasks (over 10, over 100, over 1000). Systems handling orders of magnitude more jobs and tasks will see increased benefits of the systems and methods of the inventive subject matter.

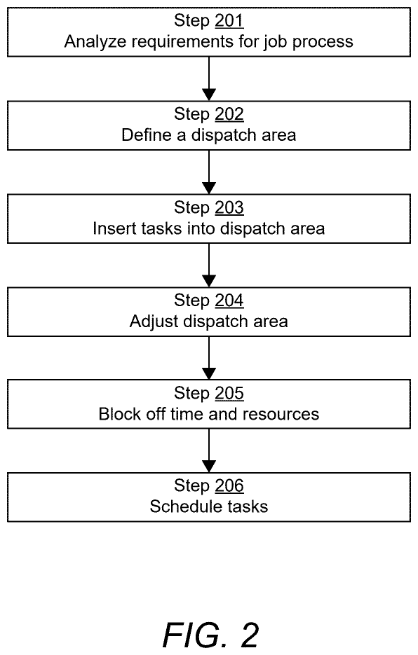

FIG. 2 is a process flowchart of the generation and application of a dispatch area to a generated genome, according to embodiments of the inventive subject matter.

At step 201, the computing device analyzes a plurality of requirements for a job process based on availability factors for a plurality of tasks associated with the job. Each of the tasks of a job includes data regarding requirements for the particular task. Examples of requirements can include materials, equipment and/or personnel required for a particular task.

At step 202, the computing device defines, using the genetic algorithm, a dispatch area. The dispatch area can be considered a section of time during which tasks and resources associated with these task are “committed” and thus unavailable and unmovable. The dispatch area can comprise a sliding window that moves down the schedule timeline of the genome.

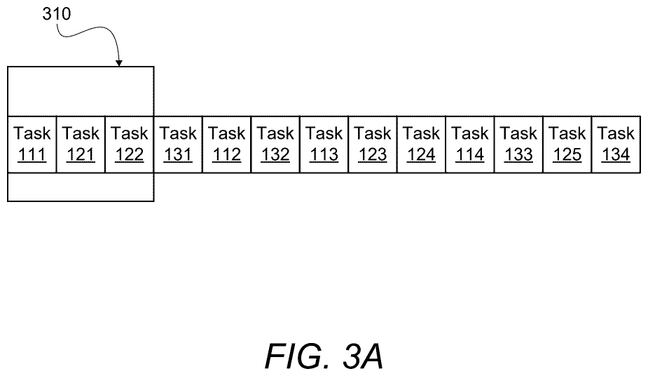

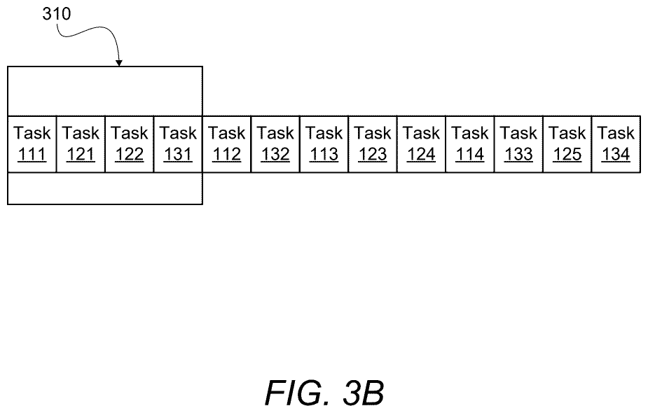

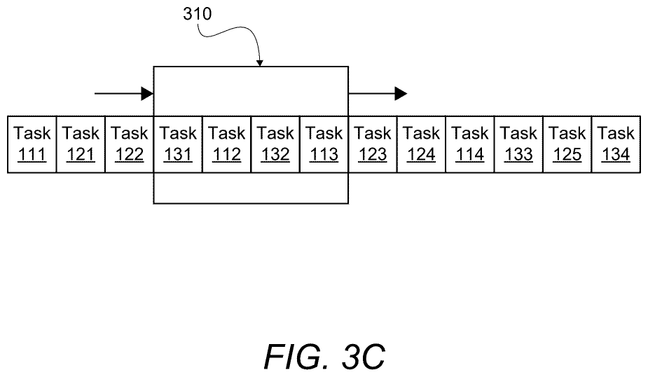

FIG. 3A shows an illustrative example of a generated dispatch area 310 that is applied to the genome 140 of FIG. 1B.

As seen in FIG. 3A, the computing device has generated a dispatch area 310 that covers tasks 111 through 122 in the genome 140 (which includes tasks 111, 121, and 122). Thus, for the initial application of the dispatch area 310, these tasks are included within the dispatch area 310. As will be further explained below, the dispatch area 310 can also be called a sliding window because of how it will move along the genome 140.

At step 203, the computing device inserts one or more tasks into the dispatch area 310 depending on the availability factors for each of the one or more tasks. The availability factors can include available resources (e.g., equipment, staff, etc.), available raw materials, available storage, etc. In the example of FIG. 3A, the computing device has inserted tasks 111, 121 and 122 during the generation of the dispatch area 310. However, at step 203 additional tasks can be added—such as from later in the genome 140 or from outside the genome 140. As will be explained below, the size of the dispatch area 310 can change. However, if the size of the dispatch area 310 is not changed, then adding tasks to the dispatch area 310 will necessarily mean that others are removed (i.e., pushed further back in the genome 140 sequence and thus will only be covered by the dispatch area 310 at a later time).

The tasks within the dispatch area 310 are considered frozen—the order cannot be changed. Thus, even after the start of the execution of the genome, the tasks outside of the dispatch area 310 could be rearranged. However, as the dispatch area 310 moves down the genome and additional tasks are introduced into the dispatch area 310, they become “frozen” and unmovable within the genome.

The sole exception to a task being frozen within a dispatch area 310 is when a task is completed. Upon the completion of the task, the computing device moves the completed task out of the dispatch area 310. The computing device can, in embodiments, insert a new task into the dispatch area 310, into the space left in the dispatch area 310. In other embodiments, the computing device can move the tasks in the genome that follow the completed task “up” into the space left by the completed task in the dispatch area 310. This movement will result in one or more tasks that were previously outside of the dispatch area 310, being brought into the dispatch area 310.

In embodiments of the inventive subject matter, the computing device executing the genetic algorithm is prevented from removing tasks that have been inserted into the dispatch area.

At step 204, the computing device adjusts the dispatch area 310 based on additional available tasks for the dispatch area and/or availability factors associated with those tasks or other tasks within the genome 140. As additional resources become available or unavailable, the sliding window of the dispatch area 310 can change. For example, as additional resources become available, the sliding window of the dispatch area 310 can be expanded (made larger) to cover more of the genome 140. This reflects the ability for the dispatch area 310 to be able to freeze more resources since more resources are available. Conversely, if resources become unavailable such that the total amount of resource is decreased, the dispatch area 310 is decreased such that less resources are committed within the dispatch area 310 at any given time.

It should be noted that, in certain situations, it will not be necessary to adjust the dispatch area 310. In these cases, the process continues on to step 205.

FIG. 3B illustrates a modification of the dispatch area 310 to enlarge it. In this visual example, the dispatch area 310 has been expanded to cover four tasks within the genome 140 (up from three tasks shown in FIG. 3A). As can be seen in FIG. 3B, task 131 is now included in the expanded dispatch area 310.

In embodiments of the inventive subject matter, the computing device is programmed to also adjust the sliding window 310 based on a time availability. For example, if a task is scheduled to begin during the end of the day, the computing device can program the sliding window 310 such that the resources frozen during the sliding window 310 are not scheduled to be occupied during the overnight or off-business hours.

In a version of these embodiments, availability factors that could affect the adjustments of dispatch area 310 based on the time availability can include a weekend unavailability or holiday unavailability that reflects the unavailability of personnel, equipment and/or a facility during a weekend or holiday period.

The adjustment of the dispatch area 310 can include an expansion of the sliding window (i.e., an increase of the time covered by the sliding window) or a contraction of the sliding window (i.e., decreasing the time covered by the sliding window).

The adjustment of the dispatch area 310 can be based on a number of availability factors. For example, and as discussed above, the computing device can be programmed to contract the dispatch area 310 based on an increased availability of resources (e.g., material, personnel, locations, etc.). This reflects that a more abundant amount of resources requires less rigidity in fixing tasks in place for execution. Conversely, the computing device can be programmed to expand the dispatch area 310 based on a decreased availability of resources, reflecting the need to ensure the critical tasks within a sliding window can be scheduled and completed.

The computing device can be programmed to determine a threshold amount of resources required for one or more tasks within one or more jobs. This threshold can be a range having an upper threshold and a lower threshold. Within the range, the dispatch area 310 can be of a default pre-determined size that accounts for regular disruptions in resource availability (e.g., weekends, known holidays, seasonal surges or shortages of materials, etc.).

At step 205, the computing device blocks off a time and at least one resource for each of the plurality of tasks within the dispatch area, as the dispatch area moves along the genome.

FIG. 3C illustrates the dispatch area 310 (enlarged in FIG. 3B) as it moves along the genome 140. As seen in FIG. 3C, the dispatch area 310 moves from the start of the genome 140 (on the left) towards the end (towards the right), as illustrated by the arrows. As the dispatch area 310 moves along the genome 140, the resources associated with those tasks are frozen accordingly. For tasks that no longer have the dispatch area 310, the resources associated with those tasks can be “unfrozen.”

In embodiments of the inventive subject matter, the computing device can store one or more of the tasks within a dispatch area for a future schedule process.

In an example, the computing device can store these tasks as a new genome. This genome can then be added to by later sections of the genome covered by the dispatch area and/or subsequent executions of the process, storing new tasks that later fall within the dispatch area of the genomes of the subsequent process. This could be considered to be a “locked” genome of tasks that cannot be moved or otherwise tampered with. In variations of these embodiments, the tasks within the locked genome could be moved relative to each other, but not changed or affected by tasks or jobs outside of the locked genome for the times and resources of execution of the tasks of the locked genome. Thus, in these embodiments, the locked genome can serve as a template for a complete or nearly complete schedule.

At step 206, the computing device proceeds to schedule the tasks according to the dispatch zone 310. As the tasks enter the dispatch area 310, they are scheduled in one or more schedules for execution. The computing device also can account for previously-schedule tasks and accommodate accordingly by looping back through the genome as needed. The scheduled tasks are communicated across all schedules controlled by the computing device. This ensures consistency and compliance with dependency requirements as well.

In embodiments of the inventive subject matter, the data associated with each task as well as the information associated with each resource used or required by each task, are each stored in a separate file or datastore for each discrete unit (i.e.. for each resource, and for each task). This separation enables task order to be preserved for any possible new genomes, and between schedule runs.

The systems and methods of the inventive subject matter are discussed herein as being executed by a computing device or computing system. The computing device is contemplated to have one or more processors, one or more non-transitory computer-readable storage medium to store executable code/instructions as well as data used in the processes discussed herein. The systems can include databases integral to or remotely from the computing devices that can store jobs (and the tasks therein). The computing devices have networking capabilities to exchange data with other computing devices, and have input/output interfaces that allow for human operators to enter and receive data/information. While “computing device” in the singular is used herein for simplicity, it is understood that the computing device can be a single computer having the components discussed herein or a plurality of communicatively connected computing devices that collectively carry out the functions and processes discussed herein.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . . and N, the text should be interpreted as requiring only one element from the group, not A plus N, or B plus N, etc.

1. A system for applying a dispatch freeze for real-world schedules in a genetic algorithm, comprising a processor programmed to:
analyze a plurality of requirements for a job process, wherein the analysis is based on availability factors for a plurality of tasks associated with the job;
define, by the genetic algorithm, a sliding window that defines a dispatch area;
insert at least one task into the dispatch area based on the availability factors for the at least one task;
adjust the sliding window based on additional available tasks for the dispatch area, based on the genetic algorithm determination of availability according to the availability factors; and
blocking off a time and at least one resource for each of the plurality of tasks within the dispatch area.

2. The system of claim 1, wherein the genetic algorithm is prevented from removing tasks from the dispatch area.

3. The system of claim 1, wherein the processor is programmed to adjust the sliding window based on a time availability.

4. The system of claim 3, wherein the time availability comprises a weekend unavailability or a holiday unavailability.

5. The system of claim 3, wherein adjusting the sliding window comprises contracting the sliding window.

6. The system of claim 3, wherein adjusting the sliding window comprises expanding the sliding window.

7. The system of claim 1, wherein the processor is further programmed to store the at least one task within the dispatch area for a future schedule process.
